(19) United States
(12) Patent Application Publication
(10) Pub. No.: US 2014/0031504 A1
(43) Pub. Date: Jan. 30, 2014

(54) CATALYST SYSTEM

(71) Applicants: Grant Berent Jacobsen, Victoria (AU); Sergio Mastroianni, Lyon (FR)

(72) Inventors: Grant Berent Jacobsen, Victoria (AU); Sergio Mastroianni, Lyon (FR)

(73) Assignee: Ineos Europe Limited, Hampshire (GB)

(21) Appl. No.: 14/041,223

(22) Filed: Sep. 30, 2013

Related U.S. Application Data
(63) Continuation of application No. 12/087,406, filed on Jul. 3, 2008, now abandoned.

(30) Foreign Application Priority Data
Jan. 11, 2006 (EP) 06250118.4

(51) Int. Cl. C08F 4/76; C08F 4/52

(52) U.S. Cl. CPC C08F 4/76; C08F 4/52
USPC 526/127; 502/124

(57) ABSTRACT

A catalyst system suitable for the polymerisation of olefins, said system comprising (a) a transition metal compound or lanthanide metal compound (b) a cocatalyst and (c) at least one porous support material characterised in that the porous support material has been pretreated with a halogen-containing organometallic compound, in particularly with a fluorine-containing organometallic compound. The catalyst system is particularly suitable for the preparation of polymers having broad molecular weight distributions from the polymerisation of olefins in the presence of a single site catalyst.

The present invention relates to a catalyst system suitable for the polymerisation and copolymerisation of olefins in particular to a catalyst system suitable for the copolymerisation of ethylene or the copolymerisation of ethylene and α-olefins having from 3 to 10 carbon atoms and also to a polymerisation processes for the modification of the molecular weight of polymers.

The invention also relates to a process for the preparation of polymers having broad molecular weight distributions from the polymerisation of olefins in the presence of a single transition metal or lanthanide metal catalyst.

In recent years there have been many advances in the production of polyolefin homopolymers and copolymers due to the introduction of metallocene catalysts. Metallocene catalysts offer the advantage of generally a higher activity than traditional Ziegler catalysts and are usually described as catalysts which are single site in nature. There have been developed several different families of metallocene complexes. In earlier years catalysts based on bis(cyclopentadienyl) metal complexes were developed, examples of which may be found in EP 129368 or EP 206794. More recently complexes having a single or mono cyclopentadienyl ring have been developed. Such complexes have been referred to as ‘constrained geometry’ complexes and examples of these complexes may be found in EP 416815 or EP 420436. In both of these complexes the metal atom eg. zirconium is in the highest oxidation state.

Other complexes however have been developed in which the metal atom may be in a reduced oxidation state. Examples of both the bis(cyclopentadienyl) and mono(cyclopentadienyl) complexes have been described in WO 96/04290 and WO 95/00526 respectively.

The above metallocene complexes are utilised for polymerisation in the presence of a cocatalyst or activator. Typically activators are aluminoxanes, in particular methyl aluminoxane or alternatively may be compounds based on boron compounds. Examples of the latter are borates such as trialkyl-substituted ammoniun tetraphenyl- or tetrafluorophenyl-borates or triarylboranes such as tris(pentafluorophenyl) borane. Catalyst systems incorporating borate activators are described in EP 561479, EP 418044 and EP 551277.

The above metallocene complexes may be used for the polymerisation of olefins in solution, slurry or gas phase. When used in the slurry or gas phase the metallocene complex and/or the activator are suitably supported. Typical supports include inorganic oxides e.g. silica or polymeric supports may alternatively be used.

Examples of the preparation of supported metallocene catalysts for the polymerisation of olefins may be found in WO 94/26793, WO 95/07939, WO 96/00245, WO 96/04318, WO 97/02297 and EP 642536.

Inorganic oxides when used as supports for polymerisation catalysts may be subjected to a heat treatment and/or chemical treatment to reduce the water content or the hydroxyl content of the support material. Typically chemical dehydration agents are reactive metal hydrides, aluminium alkyls and halides. Prior to its use the support material may be subjected to treatment at 100° C. to 1000° C. and preferably at 200 to 850° C. in an inert atmosphere under reduced pressure.

The porous supports are typically pretreated with an organometallic compound preferably an organoaluminium compound and most preferably a trialkylaluminium compound in a dilute solvent.

Preferred trialkylaluminium compounds are triethylaluminium or triisobutylaluminium.

WO 05/075525 describes supports for metallocene catalyst systems comprising inorganic oxides treated with a fluorinated functionalising agent for example diethylaluminium fluoride. The resultant fluorinated supports are used in place of traditional cocatalysts for the activation of metallocene catalyst components in the presence of organoaluminium compounds for the polymerisation of ethylene or propylene.

US 2002/007023 describes alumina supports treated with ammonium bifluoride or perfluorohexane which are used with metallocenes and organoaluminium compounds for the polymerization of olefins.

WO 03/025027 describes fluorided metal oxides as supports for phosphinimine/aluminoxane polymerization catalyst systems. The supports are pretreated for example with inorganic fluorine-containing compounds such as NaF.

US 2005/0288461 also describes fluorided silica/alumina supports for metallocene/organoaluminium catalyst systems. The supports are pretreated for example with ammonium bifluoride.

We have now found that porous supports pretreated with halogen-containing organometallic compounds may be advantageously used as components of polymerisation catalyst systems activated by suitable cocatalysts in particular for the preparation of polymers having broad molecular weight distributions.

Thus according to a first aspect of the present invention there is provided a catalyst system suitable for the polymerisation of olefins, said system comprising
(a) a transition metal compound or lanthanide metal compound
(b) a cocatalyst and
(c) at least one porous support material
   characterised in that the porous support material has been pretreated with a halogen-containing organometallic compound.

Preferred halogen-containing compounds are those comprising elements of Groups 1, 2, 13, 14, 15, 16 or 17 of the Periodic Table. Most preferred compounds are those comprising an element from Group 13.

Particularly preferred halogen-containing organometallic compounds are fluorine-containing organometallic compounds.

Particularly preferred fluorine-containing compounds are those having the general formula:

Al(R)ₓF_{y}

wherein x and y may be either 1 or 2 and R is an organic moiety.

Preferred compounds are those wherein the R groups may be the same or different and are linear or branched alkyl groups having from 1-20 carbon atoms.

Particularly suitable fluorine-containing compounds include diethylaluminium fluoride, dimethylaluminium fluoride (DMAF) or diisobutyl aluminium fluoride.

Suitable porous support materials include inorganic metal oxides or alternatively polymeric supports may be used for example polyethylene, polypropylene, clays, zeolites, etc.

Suitable inorganic metal oxides are SiO₂, Al₂O₃, MgO, ZrO₂, TiO₂, B₂O₃, CaO, ZnO and mixtures thereof.

The most preferred support material for use in the preparation of the catalyst system of the present invention is silica. Suitable silicas include Ineos ES70 and Grace Davison 948 silicas.

The support material may be subjected to a heat treatment and/or chemical treatment to reduce the water content or the hydroxyl content of the support material. Typically chemical dehydration agents are reactive metal hydrides, aluminium alkyls and halides. Prior to its use the support material may be subjected to treatment at 100° C. to 1000° C. and preferably at 200 to 850° C. in an inert atmosphere under reduced pressure.

Other suitable supports may be those described in our earlier application GB 03/05207.

The catalyst system of the present invention may advantageously additionally comprise another porous support material. For example the porous support pretreated with the halogen-containing compound may be used together with a porous support material pretreated with an organometallic compound.

The additional support material may be subjected to a heat treatment and/or chemical treatment to reduce the water content or the hydroxyl content of the support material. Typically chemical dehydration agents are reactive metal hydrides, aluminium alkyls and halides. Prior to its use the support material may be subjected to treatment at 100° C. to 1000° C. and preferably at 200 to 850° C. in an inert atmosphere under reduced pressure.

The additional porous supports are preferably pretreated with an organometallic compound preferably an organoaluminium compound and most preferably a trialkylaluminium compound in a dilute solvent.

Preferred trialkylaluminium compounds are triethylaluminium or triisobutylaluminium.

The support material is pretreated with the organometallic compound at a temperature of −20° C. to 150° C. and preferably at 20° C. to 100° C.

The transition metal compound of the present invention may suitably be any transition metal compound typically used in conjunction with a porous support in the present of a suitable cocatalyst.

The transition metal compound is typically a compound of Groups IIIA to IIB of the Periodic Table of Elements (IUPAC Version). Examples of such transition metal compounds are traditional Ziegler Natta, vanadium and Phillips-type catalysts well known in the art.

The traditional Ziegler Natta catalysts include transition metal compounds from Groups IVA-VIA, in particular catalysts based on titanium compounds of formula MRx where M is titanium and R is halogen or a hydrocarbyloxy group and x is the oxidation state of the metal. Such conventional type catalysts include TiCl₄, TiBr₄, Ti(OEt)₃Cl, Ti(OEt)₂Br₂ and similar. Traditional Ziegler Natta catalysts are described in more detail in “Ziegler-Natta Catalysts and Polymerisation” by J. Boor, Academic Press, New York, 1979.

Vanadium based catalysts include vanadyl halides eg. VCl₄, and alkoxy halides and alkoxides such as VOCl₃, VOCl₂(OBu), VCl₃(OBu) and similar. Conventional chromium catalyst compounds referred to as Phillips type catalysts include CrO₃, chromocene, silyl chromate and similar and are described in U.S. Pat. No. 4,124,532, U.S. Pat. No. 4,302,565.

Other conventional transition metal compounds are those based on magnesium/titanium electron donor complexes described for example in U.S. Pat. No. 4,302,565.

Other suitable transition metal compounds are those based on the late transition metals (LTM) of Group VIII for example compounds containing iron, nickel, manganese, ruthenium, cobalt or palladium metals. Examples of such compounds are described in WO 98/27124 and WO 99/12981 and may be illustrated by [2,6-diacetylpyridinebis(2,6-diisopropylanil)FeCl₂], 2,6-diacetylpyridinebis(2,4,6-trimethylanil)FeCl₂ and [2,6-d]acetylpyridinebis(2,6-diisopropylanil)CoCl₂].

Other suitable compounds suitable for use as the polymerisation catalyst of the present invention include derivatives of Group IIIA, IVA or Lanthanide metals which are in the +2, +3 or +4 formal oxidation state. Preferred compounds include metal complexes containing from 1 to 3 anionic or neutral ligand groups which may be cyclic or non-cyclic delocalized π-bonded anionic ligand groups. Examples of such π-bonded anionic ligand groups are conjugated or non-conjugated, cyclic or non-cyclic dienyl groups, allyl groups, boratabenzene groups, phosphole and arene groups. By the term π-bonded is meant that the ligand group is bonded to the metal by a sharing of electrons from a partially delocalised π-bond.

Each atom in the delocalized π-bonded group may independently be substituted with a radical selected from the group consisting of hydrogen, halogen, hydrocarbyl, halohydrocarbyl, hydrocarbyl, substituted metalloid radicals wherein the metalloid is selected from Group IVB of the Periodic Table. Included in the term “hydrocarbyl” are C1-C20 straight, branched and cyclic alkyl radicals, C6-C20 aromatic radicals, etc. In addition two or more such radicals may together form a fused ring system or they may form a metallocycle with the metal.

Examples of suitable anionic, delocalised π-bonded groups include cyclopentadienyl, indenyl, fluorenyl, tetrahydroindenyl, tetrahydrofluorenyl, octahydrofluorenyl, etc. as well as phospholes and boratabenzene groups.

Phospholes are anionic ligands that are phosphorus containing analogues to the cyclopentadienyl groups. They are known in the art and described in WO 98/50392.

The boratabenzenes are anionic ligands that are boron containing analogues to benzene. They are known in the art and are described in Organometallics, 14, 1, 471-480 (1995).

The preferred transition metal catalyst of the present invention is a bulky ligand compound also referred to as a metallocene complex containing at least one of the aforementioned delocalized π-bonded group, in particular cyclopentadienyl ligands. Such metallocene complexes are those based on Group IVA metals for example titanium, zirconium and hafnium.

Metallocene complexes may be represented by the general formula:

LxMQn

where L is a cyclopentadienyl ligand, M is a Group IVA metal, Q is a leaving group and x and n are dependent upon the oxidation state of the metal.

Typically the Group IVA metal is titanium, zirconium or hafnium, x is either 1 or 2 and typical leaving groups include halogen or hydrocarbyl. The cyclopentadienyl ligands may be substituted for example by alkyl or alkenyl groups or may comprise a fused ring system such as indenyl or fluorenyl.

Examples of suitable metallocene complexes are disclosed in EP 129368 and EP 206794. Such complexes may be unbridged eg. bis(cyclopentadienyl)zirconium dichloride, bis(pentamethyl)cyclopentadienyl dichloride, or may be bridged eg. ethylene bis(indenyl)zirconium dichloride or dimethylsilyl(indenyl)zirconium dichloride.

Other suitable bis(cyclopentadienyl) metallocene complexes are those bis(cyclopentadienyl)diene complexes described in WO 96/04290. Examples of such complexes are bis(cyclopentadienyl)zirconium (2,3-dimethyl-1,3-butadiene) and ethylene bis(indenyl)zirconium 1,4-diphenyl butadiene.

Examples of monocyclopentadienyl or substituted monocyclopentadienyl complexes suitable for use in the present invention are described in EP 416815, EP 418044, EP 420436 and EP 551277. Suitable complexes may be represented by the general formula:

CpMXₙ

wherein Cp is a single cyclopentadienyl or substituted cyclopentadienyl group optionally covalently bonded to M through a substituent, M is a Group VIA metal bound in a η⁵ bonding mode to the cyclopentadienyl or substituted cyclopentadienyl group, X each occurrence is hydride or a moiety selected from the group consisting of halo, alkyl, aryl, aryloxy, alkoxy, alkoxyalkyl, amidoalkyl, siloxyalkyl etc. having up to 20 non-hydrogen atoms and neutral Lewis base ligands having up to 20 non-hydrogen atoms or optionally one X together with Cp forms a metallocycle with M and n is dependent upon the valency of the metal.

Particularly preferred monocyclopentadienyl complexes have the formula:

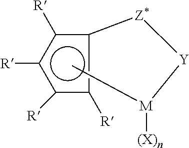

wherein:—

R′ each occurrence is independently selected from hydrogen, hydrocarbyl, silyl, germyl, halo, cyano, and combinations thereof, said R′ having up to 20 nonhydrogen atoms, and optionally, two R′ groups (where R′ is not hydrogen, halo or cyano) together form a divalent derivative thereof connected to adjacent positions of the cyclopentadienyl ring to form a fused ring structure;

X is hydride or a moiety selected from the group consisting of halo, alkyl, aryl, aryloxy, alkoxy, alkoxyalkyl, amidoalkyl, siloxyalkyl etc. having up to 20 non-hydrogen atoms and neutral Lewis base ligands having up to 20 non-hydrogen atoms,

Y is —O—, —S—, —NR*—, —PR*—,

M is hafnium, titanium or zirconium,

Z* is SiR*₂, CR*₂, SiR*₂SIR*₂, CR*₂CR*₂, CR*═CR*, CR*₂SIR*₂, or

GeR*₂, wherein:

R* each occurrence is independently hydrogen, or a member selected from hydrocarbyl, silyl, halogenated alkyl, halogenated aryl, and combinations thereof, said

R* having up to 10 non-hydrogen atoms, and optionally, two R* groups from Z* (when R* is not hydrogen), or an R* group from Z* and an R* group from Y form a ring system,

and n is 1 or 2 depending on the valence of M.

Examples of suitable monocyclopentadienyl complexes are (tert-butylamido)dimethyl(tetramethyl-η⁵-cyclopentadienyl) silanetitanium dichloride and (2-methoxyphenylamido)dimethyl(tetramethyl-η⁵-cyclopentadienyl) silanetitanium dichloride.

Other suitable monocyclopentadienyl metallocene complexes are those comprising phosphinimine ligands described in WO 99/40125, WO 00/05237, WO 00/05238 and WO00/32653. A typical examples of such a complex is cyclopentadienyl titanium [tri(tertiary butyl)phosphinimine]dichloride.

Particularly preferred metallocene complexes for use in the preparation of the supported catalysts of the present invention may be represented by the general formula:

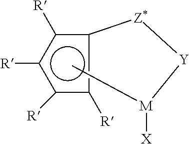

wherein:—

R′ each occurrence is independently selected from hydrogen, hydrocarbyl, silyl, germyl, halo, cyano, and combinations thereof, said R′ having up to 20 nonhydrogen atoms, and optionally, two R′ groups (where R′ is not hydrogen, halo or cyano) together form a divalent derivative thereof connected to adjacent positions of the cyclopentadienyl ring to form a fused ring structure;

X is a neutral η⁴ bonded diene group having up to 30 non-hydrogen atoms, which forms a π-complex with M;

Y is —O—, —S—, —NR*—, —PR*—,

M is titanium or zirconium in the +2 formal oxidation state;

Z* is SiR*₂, CR*₂, SiR*₂SIR*₂, CR*₂CR*₂, CR*═CR*, CR*₂SIR*₂, or

GeR*₂, wherein:

R* each occurrence is independently hydrogen, or a member selected from hydrocarbyl, silyl, halogenated alkyl, halogenated aryl, and combinations thereof, said

R* having up to 10 non-hydrogen atoms, and optionally, two R* groups from Z* (when R* is not hydrogen), or an R* group from Z* and an R* group from Y form a ring system.

Examples of suitable X groups include s-trans-η⁴-1,4-diphenyl-1,3-butadiene, s-trans-η⁴-3-methyl-1,3-pentadiene; s-trans-η⁴-2,4-hexadiene; s-trans-η⁴-1,3-pentadiene; s-trans-η⁴-1,4-ditolyl-1,3-butadiene; s-trans-η⁴-1,4-bis(trimethylsilyl)-1,3-butadiene; s-cis-η⁴-3-methyl-1,3-pentadiene; s-cis-η⁴-1,4-dibenzyl-1,3-butadiene; s-cis-η⁴-1,3-pentadiene; s-cis-η⁴-1,4-bis(trimethylsilyl)-1,3-butadiene, said s-cis diene group forming a π-complex as defined herein with the metal.

Most preferably R′ is hydrogen, methyl, ethyl, propyl, butyl, pentyl, hexyl, benzyl, or phenyl or 2 R′ groups (except hydrogen) are linked together, the entire C₅R′₄ group thereby being, for example, an indenyl, tetrahydroindenyl, fluorenyl, terahydrofluorenyl, or octahydrofluorenyl group.

Highly preferred Y groups are nitrogen or phosphorus containing groups containing a group corresponding to the formula —N(R″)— or —P(R″)— wherein R″ is C₁₋₁₀ hydrocarbyl.

Most preferred complexes are amidosilane- or amidoalkanediyl complexes.

Most preferred complexes are those wherein M is titanium.

Specific complexes suitable for use in the preparation of the supported catalysts of the present invention are those disclosed in WO 95/00526 and are incorporated herein by reference.

A particularly preferred complex for use in the preparation of the supported catalysts of the present invention is (t-butylamido) (tetramethyl-η⁵-cyclopentadienyl)dimethyl silanetitanium-η⁴-1,3-pentadiene.

Suitable cocatalysts for use in the catalyst system of the present invention are those typically used with the aforementioned transition metal compounds.

These include aluminoxanes such as methyl aluminoxane (MAO), boranes such as tris(pentafluorophenyl) borane and borates.

Aluminoxanes are well known in the art and preferably comprise oligomeric linear and/or cyclic alkyl aluminoxanes. Aluminoxanes may be prepared in a number of ways and preferably are prepared by contacting water and a trialkylaluminium compound, for example trimethylaluminium, in a suitable organic medium such as benzene or an aliphatic hydrocarbon.

A preferred aluminoxane is methyl aluminoxane (MAO).

Other suitable cocatalysts are organoboron compounds in particular triarylboron compounds. A particularly preferred triarylboron compound is tris(pentafluorophenyl) borane.

Other compounds suitable as cocatalysts are compounds which comprise a cation and an anion. The cation is typically a Bronsted acid capable of donating a proton and the anion is typically a compatible non-coordinating bulky species capable of stabilizing the cation.

Such cocatalysts may be represented by the formula:

(L*-H)⁺_{d}(A^{d-})

wherein
L* is a neutral Lewis base
(L*-H)⁺_{d} is a Bronsted acid
A^{d-} is a non-coordinating compatible anion having a charge of d⁻, and
d is an integer from 1 to 3.

The cation of the ionic compound may be selected from the group consisting of acidic cations, carbonium cations, silylium cations, oxonium cations, organometallic cations and cationic oxidizing agents.

Suitably preferred cations include trihydrocarbyl substituted ammonium cations eg. triethylammonium, tripropylammonium, tri(n-butyl)ammonium and similar. Also suitable are N,N-dialkylanilinium cations such as N,N-dimethylanilinium cations.

The preferred ionic compounds used as cocatalysts are those wherein the cation of the ionic compound comprises a hydrocarbyl substituted ammonium salt and the anion comprises an aryl substituted borate.

Typical borates suitable as ionic compounds include:
triethylammonium tetraphenylborate
triethylammonium tetraphenylborate,
tripropylammonium tetraphenylborate,
tri(n-butyl)ammonium tetraphenylborate,
tri(t-butyl)ammonium tetraphenylborate,
N,N-dimethylanilinium tetraphenylborate,
N,N-diethylanilinium tetraphenylborate,
trimethylammonium tetrakis(pentafluorophenyl) borate,
triethylammonium tetrakis(pentafluorophenyl),
tripropylammonium tetrakis(pentafluorophenyl) borate,
tri(n-butyl)ammonium tetrakis(pentafluorophenyl) borate,
N,N-dimethylanilinium tetrakis(pentafluorophenyl) borate,
N,N-diethylanilinium tetrakis(pentafluorophenyl) borate.

A preferred type of cocatalyst suitable for use with the metallocene complexes of the present invention comprise ionic compounds comprising a cation and an anion wherein the anion has at least one substituent comprising a moiety having an active hydrogen.

Suitable cocatalysts of this type are described in WO 98/27119 the relevant portions of which are incorporated herein by reference.

Examples of this type of anion include:
triphenyl(hydroxyphenyl) borate
tri(p-tolyl)(hydroxyphenyl) borate
tris(pentafluorophenyl)(hydroxyphenyl) borate
tris(pentafluorophenyl)(4-hydroxyphenyl) borate

Examples of suitable cations for this type of cocatalyst include
triethylammonium, triisopropylammonium, diethylmethylammonium, dibutylethylammonium and similar.

Particularly suitable are those cations having longer alkyl chains such as dihexyldecylmethylammonium, dioctadecylmethylammonium, ditetradecylmethylammonium, bis(hydrogentated tallow alkyl)methylammonium and similar.

Particular preferred cocatalysts of this type are alkylammonium tris(pentafluorophenyl) 4-(hydroxyphenyl) borates. A particularly preferred cocatalyst is bis(hydrogenated tallow alkyl)methyl ammonium tris(pentafluorophenyl) (4-hydroxyphenyl) borate.

With respect to this type of cocatalyst, a preferred compound is the reaction product of an alkylammonium tris(pentafluorophenyl)-4-(hydroxyphenyl) borate and an organometallic compound, for example triethylaluminium or an aluminoxane.

The present invention is particularly suitable for catalyst systems comprising non-aluminium containing cocatalysts in particular for non-aluminoxane containing cocatalysts.

Thus according to another aspect of the present invention there is provided a catalyst system suitable for the polymerisation of olefins, said system comprising
(a) a transition metal compound or lanthanide metal compound
(b) a non-aluminium containing cocatalyst and
(c) at least one porous support material
   characterised in that the porous support material has been pretreated with a halogen-containing compound.

Particularly preferred halogen-containing compounds are halogen-containing organometallic compounds in particular fluorine-containing organometallic compounds as hereinbefore described.

Particularly preferred non-aluminium containing cocatalysts are boron-containing cocatalysts as hereinbefore described

The present invention is particularly suitable for use with metallocene complexes which have been treated with polymerisable monomers. Our earlier applications WO 04/020487 and WO 05/019275 describe supported catalyst compositions wherein a polymerisable monomer is used in the catalyst preparation.

Thus according to another aspect of the present invention there is provided a catalyst system suitable for the polymerisation of olefins, said system comprising
(a) a metallocene complex,
(b) a cocatalyst,
(c) a polymerisable monomer, and
(d) at least one porous support material
   characterised in that the porous support material has been pretreated with a halogen-containing organometallic compound.

Suitable halogen-containing organometallic compounds for this aspect of the present invention are as hereinbefore described.

Particularly preferred halogen-containing organometallic compounds are fluorine-containing organometallic compounds as hereinbefore described.

Polymerisable monomers suitable for use in this aspect of the present invention include ethylene, propylene, 1-butene, 1-hexene, 1-octene, 1-decene, styrene, butadiene, and polar monomers for example vinyl acetate, methyl methacrylate, etc. Preferred monomers are those having 2 to 10 carbon atoms in particular ethylene, propylene, 1-butene or 1-hexene.

Alternatively a combination of one or more monomers may be used for example ethylene/1-hexene.

The preferred polymerisable monomer is 1-hexene.

The polymerisable monomer is suitably used in liquid form or alternatively may be used in a suitable solvent. Suitable solvents include for example heptane.

The polymerisable monomer may be added to the cocatalyst before addition of the metallocene complex or alternatively the complex may be pretreated with the polymerisable monomer.

The catalyst systems of the present invention are most suitable for operation in processes which typically employ supported polymerisation catalysts.

The supported catalysts of the present invention may be suitable for the polymerisation of olefin monomers selected from (a) ethylene, (b) propylene (c) mixtures of ethylene and propylene and (d) mixtures of (a), (b) or (c) with one or more other alpha-olefins.

Thus according to another aspect of the present invention there is provided a process for the polymerisation of olefin monomers selected from (a) ethylene, (b) propylene (c) mixtures of ethylene and propylene and (d) mixtures of (a), (b) or (c) with one or more other alpha-olefins, said process performed in the presence of a supported polymerisation catalyst system prepared as hereinbefore described.

The supported systems of the present invention are however most suitable for use in slurry or gas phase processes.

A slurry process typically uses an inert hydrocarbon diluent and temperatures from about 0° C. up to a temperature just below the temperature at which the resulting polymer becomes substantially soluble in the inert polymerisation medium. Suitable diluents include toluene or alkanes such as hexane, propane or isobutane. Preferred temperatures are from about 30° C. up to about 200° C. but preferably from about 60° C. to 100° C. Loop reactors are widely used in slurry polymerisation processes.

Gas phase processes for the polymerisation of olefins, especially for the homopolymerisation and the copolymerisation of ethylene and α-olefins for example 1-butene, 1-hexene, 4-methyl-1-pentene are well known in the art.

Typical operating conditions for the gas phase are from 20° C. to 100° C. and most preferably from 40° C. to 85° C. with pressures from subatmospheric to 100 bar.

Particularly preferred gas phase processes are those operating in a fluidised bed. Examples of such processes are described in EP 89691 and EP 699213 the latter being a particularly preferred process for use with the supported catalysts of the present invention.

Particularly preferred polymerisation processes are those comprising the polymerisation of ethylene or the copolymerisation of ethylene and α-olefins having from 3 to 10 carbon atoms.

Thus according to another aspect of the present invention there is provided a process for the polymerisation of ethylene or the copolymerisation of ethylene and α-olefins having from 3 to 10 carbon atoms, said process performed under polymerisation conditions in the present of a supported catalyst system prepared as hereinbefore described.

The preferred α-olefins are 1-butene, 1-hexene, 4-methyl-1-pentene and 1-octene.

By use of the particular porous supports of the present invention the molecular weight capability of a single site catalyst may be modified. For example the combination of a fluorinated silica and a non-fluorinated silica may lead to polymers having a broad molecular weight distribution.

By single site catalyst is meant a catalyst which is defined as producing a narrow molecular weight distribution polymer as compared with a traditional Ziegler-Natta catalyst system having less defined catalyst sites producing polymers having a broader molecular weight distribution.

Typically polymers having molecular weight distributions >4, preferably >5 and most preferably >6 may suitably be prepared.

By careful choice of the catalyst system the skilled man may be able to produce polymers having from a small degree of broadening of molecular weight to a fully bimodal polymer.

Comonomer incorporation may also be modified by use of the catalyst systems of the present invention.

Thus according to another aspect of the present invention there is provided a method for the preparation of polymers having a molecular weight distribution >4, said method comprising polymerisation in a single reactor in the presence of a single site catalyst system, said system comprising
(a) a transition metal compound,
(b) a cocatalyst,
(c) a first porous support material pretreated with a halogen-containing compound, and
(d) a second porous support material.

Preferably polymers having a molecular weight distribution >5 and most preferably >6 may be prepared.

Suitable halogen-containing compounds for this aspect of the present invention are as hereinbefore described. Preferred halogen-containing compounds are fluorine-containing compounds.

Preferably the second porous support material has been pretreated with an organometallic compound preferably an organoaluminium compound and most preferably a trialkylaluminium compound in a dilute solvent.

Preferred trialkylaluminium compounds are triethylaluminium or triisobutylaluminium.

The preferred transition metal compound for use in this aspect of the present invention is a bulky ligand compound also referred to as a metallocene complex as aforementioned.

This aspect of the present invention may also comprise the use of a single porous support pretreated with a mixture of a fluorine containing compound of the formula hereinbefore described and an organometallic compound for example a trialkylaluminium compound.

In this way polymers having a broad molecular weight distribution may be obtained by use of a catalyst system comprising a single transition metal compound or lanthanide compound and a single support.

The present invention will now be illustrated with reference to the accompanying examples:

### ABBREVIATIONS

TEA triethylaluminium
DMAF dimethylaluminium fluoride
Ionic Compound A [N(H)Me(C₁₈₋₂₂H₃₇₋₄₅)₂][B(C₆F₅)₃(p-OHC₆H₄)]
Complex A (C₅Me₄SiMe₂N^{t}Bu)Ti(η⁴-1,3-pentadiene)

### Example 1

### Synthesis of dimethylaluminium fluoride (DMAF) (from US2005143254 A)

To a suspension 15.7 g of potassium fluoride in 57.8 ml of toluene was added dropwise a solution obtained by mixing 24.2 ml of dimethylaluminium chloride and 30 ml of toluene. The rate of addition was regulated to maintain the temperature medium below 50° C. After the addition, the mixture was stirred overnight at 50° C.

The liquid phase was separated from the solids and used without further treatment.

[Al]=2.45 mol/l

Treatment of Silica with DMAF

To 2.87 g of silica Sylpol 948, previously calcined at 250° C. for 5 h under nitrogen, was added 2.4 ml of the above prepared DMAF solution. The mixture was allowed to react for 1 hour then the solid was washed 8 times with 50 ml hexane and finally dried under vacuum

### Preparation of Catalyst System

To 1.61 ml (0.12 mmol) of a 9.58% solution of Ionic Compound A in toluene was added 0.12 ml of an hexane solution of TEA (1 mol/l). The mixture was allowed to react for 15 minutes and then was added to 2 g of the above prepared DMAF treated silica. The mixture was well agitated until non lumps were visible and was allowed to stand for 30 min.

To 0.55 ml (0.11 mmol) of a 10.4% solution of Complex A in heptane was added 0.49 ml of pure 1-hexene and the mixture was then added to the silica/TEA/borate mixture prepared above.

The mixture was well agitated for 30 minutes to allow a good dispersion and was finally dried under vacuum to yield a green free flowing powder.

### Example 2

To 1.54 ml (0.12 mmol) of a 10% solution of Ionic Compound A in toluene was added 0.12 ml of an hexane solution of TEA (1 mol/l). The mixture was allowed to react for 15 minutes and then was added to mixture of 67 mg of the above prepared DMAF treated silica and 133 mg of TEA treated silica (i.e 2/3 TEA silica and 1/3 DMAF treated silica). The mixture was well agitated until no lumps were visible and was allowed to stand for 30 min.

To 0.55 ml (0.11 mmol) of a 10.4% solution of Complex A in heptane was added 0.49 ml of pure 1-hexene and the mixture was then added to the silica/TEA/borate mixture prepared above.

The mixture was well agitated for 30 minutes to allow a good dispersion and was finally dried under vacuum to yield a green free flowing powder.

### Example 3 (Comparative)

To 1.54 ml (0.12 mmol) of a 10% solution of Ionic Compound A in toluene was added 0.12 ml of an hexane solution of TEA (1 mol/l).

The mixture was allowed to react for 15 minutes and then was added to 2 g of TEA treated silica ([Al]=1.34 mmol/g). The mixture was well agitated until non lumps were visible and was allowed to stand for 30 min.

To 0.55 ml (0.11 nmol) of a 10.4% solution of Complex Ain heptane was added 0.49 ml of pure 1-hexene and the mixture was then added to the silica/TEA/borate mixture prepared above.

The mixture was well agitated for 30 minutes to allow a good dispersion and was finally dried under vacuum to yield a green free flowing powder

### Polymerisation Runs

The above catalysts were tested for ethylene-1-hexene copolymerisation in an 250 ml agitated dried phase reactor. as follows;

The following condition were used:
seed bed: dried NaCl (70 g)
scavenger: TEA treated silica (0.15 g)
PC2: 10 b
C6/C2 (% vol)=0.8
H2/C2 (% vol)=0.3
T°=80° C.
run length: 80 min

At the end of the run the reactor content was washed several times with water to eliminate the salt bed and the obtained polymer was finally dried at 45° C. overnight.

The polymerisation results are summarised in the following table:

| | | | | Example 4 |
|---|---|---|---|---|
| | | | | (catalyst from |
| | | | Example 3 | example 3) |
| Catalyst | Example 1 | Example 2 | Comparative | Comparative |
| Catalyst | 15.5 | 11.1 | 12.4 | 15.7 |
| injected (mg) | | | | |
| Production (g) | 3.6 | 2.3 | 5.2 | 6.4 |
| Yield (g/g) | 230 | 210 | 420 | 407 |
| Tm (° C.) | 129 | 125 | 113.2 | 114.5 |
| Mn | | 30800 | 68000 | 78500 |
| Mw | >2,000,000 | 198000 | 231000 | 257000 |
| Mw/Mn | | 6.5 | 3.39 | 3.28 |
| CH3 groups/ | 6.3 | 11.5 | 14.3 | 14.1 |
| 1000 C atoms | | | | |

### FTIR Polymer Analysis for Butyl Branches in Ethylene/Hexene Copolymer

A sample of the dry polymer was first pressed in to a disc of ˜100 μm thickness using a hydraulic press at a pressure of 50 kN at 160° C. for 90 seconds. The absorption spectrum of each sample over a range of 5000 to 400 cm⁻¹ was recorded using a Perkin Elmer Spectrum One FT-IR instrument and the absorbance band at 1377 cm⁻¹, corresponding to the CH₃— end groups of C₄ chains, measured. The comonomer content was then determined by comparison with a calibration curve obtained using reference samples of known comonomer content previously determined by NMR analysis.

### GPC Analysis

### 1.1 General Set-Up and Information

Instrument is a Polymer Laboratories GPC220
Column is a single PLgel HTS-B (150×7.5 mm) for rapid GPC
All solvent 1,2,4-trichlorobenzene is stabilised with 1.0 g/l BHT
Elution rate 1.0 ml/min
Column temp is 160° C.
Detection is by differential refractive index

### 1.2 Sample Preparation

4.5 mg of each sample is dissolved in 10 ml of stabilised TCB by shaking in a PL SP260 dissolution rig at 160° C. for 120 minutes.
2 ml of each solution is transferred to glass sample vials (any samples exhibiting a gelatinous nature are not run) and the vials capped.
Vials are loaded into the GPC heated autosampler chamber (wash vial at start and finish) for automatic injection onto the column.

### 1.3 Data Capture and Handling

PL Cirrus GPC Online software (v 1.2) is used to collect and present the data generated.
The system is calibrated using a reference polystyrene sample and the following K and α values used to correct for polyethylene.
   PS K=12.1α=0.707
   PE K=40.6α=0.725.

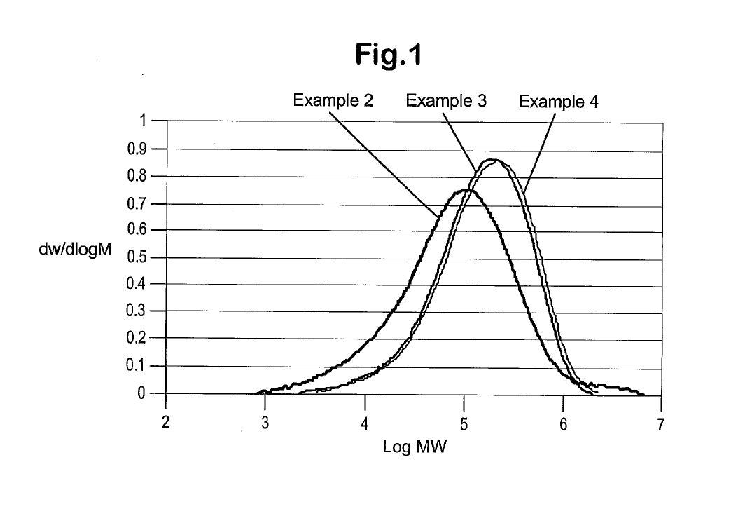

The corresponding GPC plots of the examples are shown below in the attached FIG. 1 where it can be clearly seen from the plot that the polymer from example 2 shows a broad MWD with an important fraction of Mw>1,000,000 compared to comparative examples 3 and 4.

1. A catalyst system suitable for the polymerisation of olefins, said system comprising
(a) a transition metal compound or lanthanide metal compound
(b) a cocatalyst and
(c) at least one porous support material
characterised in that the porous support material has been pretreated with a halogen-containing organometallic compound.

2. A catalyst system according to claim 1 wherein the halogen-containing organometallic compound comprises elements of Groups 1, 2, 13, 14, 15, 16 or 17 of the Periodic Table.

3. A catalyst system according to claim 2 wherein the element is a Group 13 element.

4. A catalyst system according to claim 1 wherein the halogen-containing organometallic compound is a fluorine-containing organometallic compound.

5. A catalyst system according to claim 4 wherein the fluorine-containing organometallic compound has the formula
A1RₓF_{y}
wherein x and y may be either 1 or 2 and R is an organic moiety.

6. A catalyst system according to claim 5 wherein the R groups may be the same or different and are linear or branched alkyl groups having from 1-20 carbon atoms.

7. A catalyst system according to claim 5 wherein the fluorine-containing organometallic compound is diethylaluminium fluoride, dimethylaluminium fluoride (DMAF) or diisobutyl aluminium fluoride.

8. A catalyst system according to claim 1 wherein the porous support material is silica.

9. A catalyst system according to claim 1 comprising (a) a first porous support material pretreated with a halogen-containing organometallic compound and (b) a second porous support material.

10. A catalysts system according to claim 9 wherein the second porous support material has been pretreated with a trialkylaluminium compound.

11. A catalyst system according to claim 1 wherein the transition metal compound is a metallocene complex.

12. A catalyst system according to claim 10 wherein the metallocene is a monocyclopentadienyl metallocene complex.

13. A catalyst system according to claim 11 wherein the metallocene complex has the general formula: 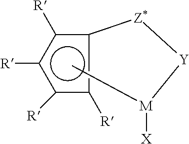
wherein:—
R′ each occurrence is independently selected from hydrogen, hydrocarbyl, silyl, germyl, halo, cyano, and combinations thereof, said R′ having up to 20 nonhydrogen atoms, and optionally, two R′ groups (where R′ is not hydrogen, halo or cyano) together form a divalent derivative thereof connected to adjacent positions of the cyclopentadienyl ring to form a fused ring structure;
X is a neutral η⁴ bonded diene group having up to 30 non-hydrogen atoms, which forms a π-complex with M;
Y is —O—, —S—, —NR*—, —PR*—,
M is titanium or zirconium in the +2 formal oxidation state;
Z* is SiR*₂, CR*₂, SiR*₂SIR*₂, CR*₂CR*₂, CR*═CR*, CR*₂SIR*₂, or GeR*₂,
wherein:
R* each occurrence is independently hydrogen, or a member selected from hydrocarbyl, silyl, halogenated alkyl, halogenated aryl, and combinations thereof, said
R* having up to 10 non-hydrogen atoms, and optionally, two R* groups from Z* (when R* is not hydrogen), or an R* group from Z* and an R* group from Y form a ring system.

14. A catalyst system according to claim 12 wherein the metal is titanium.

15. A catalyst system according to claim 1 wherein the cocatalyst is represented by the formula:
(L*-H)⁺_{d}(A^{d-})
wherein
L* is a neutral Lewis base
(L*-H)⁺_{d} is a Bronsted acid
A^{d} is a non-coordinating compatible anion having a charge of d⁻, and d is an integer from 1 to 3.

16. A catalyst system suitable for the polymerisation of olefins, said system comprising
(a) a transition metal compound or lanthanide metal compound,
(b) a non-aluminium containing cocatalyst and
(c) at least one porous support material
characterised in that the porous support material has been pretreated with a halogen-containing compound.

17. A catalyst system according to claim 15 wherein the halogen-containing compound is a halogen-containing organometallic compound.

18. A catalyst system according to claim 15 wherein the halogen-containing compounds are fluorine-containing compounds.

19. A catalyst system suitable for the polymerization of olefins, said system comprising
(a) a metallocene complex,
(b) a cocatalyst,
(c) a polymerisable monomer, and
(d) at least one porous support material
characterised in that the porous support material has been pretreated with a halogen-containing organometallic compound.

20. A catalyst system according to claim 18 wherein the halogen-containing organometallic compound is a fluorine-containing organometallic compound.

21. A catalyst system according to claim 18 wherein the polymerisable monomer is 1-hexene.

22. A process for the polymerisation of olefin monomers selected from (a) ethylene, (b) propylene (c) mixtures of ethylene and propylene and (d) mixtures of (a), (b) or (c) with one or more other alpha-olefins, said process performed in the presence of a supported polymerisation catalyst system prepared as claimed in claim 1.

23. A process for the polymerisation of ethylene or the copolymerisation of ethylene and α-olefins having from 3 to 10 carbon atoms, said process performed under polymerisation conditions in the present of a supported catalyst system prepared according to claim 1.

24. A process according to claim 21 wherein the α-olefins are chosen from 1-butene, 1-hexene, 4-methyl-1-pentene and 1-octene.

25. A process according to claim 21 performed in the gas phase.

26. A method for the preparation of polymers having a molecular weight distribution>4, said method comprising polymerisation in a single reactor in the presence of a single site catalyst system, said system comprising
(a) a transition metal compound,
(b) a cocatalyst,
(c) a first porous support material pretreated with a halogen-containing compound, and
(d) a second porous support material.

27. A method according to claim 25 wherein the polymers have a molecular weight distribution>5.

28. A method according to claim 25 wherein the polymers have a molecular weight distribution>6.

29. A method according to claim 25 wherein the second porous support material has been pretreated an organometallic compound.

30. A method according to claim 28 wherein the organometallic compound is a trialkylaluminium compound.

31. A method according to claim 25 wherein the halogen-containing compound is a fluorine-containing compound.

32. A method according to claim 25 wherein the transition metal compound is a metallocene complex.
